(19) United States
(12) Patent Application Publication
(10) Pub. No.: US 2005/0158501 A1
(43) Pub. Date: Jul. 21, 2005

(54) Covering having an integral barrier for use on treated boards

(75) Inventor: Lawrence J. O'Connor, Venice, FL (US)

Correspondence Address: ROBERTS, MLOTKOWSKI & HOBBES, P. O. BOX 10064, MCLEAN, VA, 22102, US

(73) Assignee: O'Connor Investment Corp., Winnipeg (CA)

(21) Appl. No.: 10/821,202

(22) Filed: Apr. 9, 2004

Related U.S. Application Data
(60) Provisional application No. 60/536,711, filed on Jan. 16, 2004.

(51) Int. Cl. B32B 9/00

(52) U.S. Cl. 428/40.1; 428/95

(57) ABSTRACT

A covering system is designed as an elongated strip of covering material having an outer layer, a barrier layer laminated thereto and an integral moldable layer secured to the barrier layer for mounting on the surface of boards, such as deck planks. In a preferred embodiment, strips are preferably secured to the length of the boards solely by a layer of a pressure sensitive adhesive carried by the strip. The moldable material is applied in an amount of about at least 185 grams per square meter. A removable release sheet covers the adhesive surface of the moldable material. The release sheet can include a positioning mechanism and indicia such as the direction of the pile and measuring guides. The moldable layer provides sufficient adhesion across the width of the strip for both initial application and sufficient thickness for subsequently molding to the board surface for long term adhesion. The barrier layer is impermeable and provides protection against dermal contact with the surface of treated lumber.

### CROSS REFERENCE TO RELATED APPLICATIONS

This application claims priority to U.S. provisional application No. 60/536,711 filed Jan. 16, 2004. The contents of that provisional application are incorporated herein by reference.

### STATEMENT REGARDING FEDERALLY SPONSORED RESEARCH OR DEVELOPMENT

[Not Applicable]

### REFERENCE TO A SEQUENCE LISTING

[Not Applicable]

### BACKGROUND OF THE INVENTION

1. Field of the Invention

This invention relates to coverings for exterior surfaces, especially surfaces such as floors, decks, docks, and play sets. In particular, this invention relates to self securing carpeting with an impermeable barrier layer that is usable on building elements and the method of installation. This invention is especially applicable to techniques for providing a dermal barrier for treated lumber.

2. Discussion of Related Art

Decks, platforms and play sets formed of boards suitable for exterior use are well known in the building industry. Decks are commonly used as extensions from buildings, either elevated or at ground surface, like a patio. Docks or piers also commonly have a top surface formed as a deck. As most decks are used outdoors, decks are commonly built as a platform of spaced boards. The spacing between boards promotes drainage of the platform and allows debris to fall between the boards. Decks are very popular in all regions of the world, especially in residential areas.

One of the main attractions of a deck is that is can be formed by relatively simple construction of boards or planks. This construction provides an effective supporting surface at a reasonable cost. Most decks are built of wooden boards, as wood is a relatively inexpensive and easily handled building material. However, exposed wood is liable to surface deterioration due to the wetting and drying process and year round exposure to the elements and temperature extremes. Thus, the surface can become unsatisfactory in that it can leave dangerous splinters. Wood and other wood like materials also become slippery when wet.

Most exterior boards have been treated, especially pressure treated, to provide a surface that resists rotting and damage from pests. About 90% of all pressure-treated wood contains chromated copper arsenate (CCA), which has been linked to bladder, liver, and lung cancer. A draft study by the Environmental Protection Agency (EPA) found that children who play frequently on CCA treated structures could have a lifetime risk of an arsenic related cancer that is as high as one in 100,000. This is ten times the risk threshold that the EPA usually considers a significant public health threat, which is one-in-a-million. Due to this cancer risk, the production of pressure treated lumber used for millions of decks, fences and play sets has been recently phased out. It is estimated that 50 million home owners in the U.S. have existing pressure treated structures. Industry experts estimate that 75 billion feet of CCA treated boards are in use nationwide.

The cost of entirely replacing these existing boards would be immense. Further, disposal of CCA laced boards poses additional environmental concerns. It would be desirable to minimize contact with the treated boards in order to reduce the risk of exposure to the carcinogens in the boards.

Some homeowners cover deteriorated deck surfaces with a carpeting material or the like, which provides a comfortable slip resistant walking surface, avoids the possibility of splinters, and can inhibit the deterioration of the wood due to weathering. Simply laying a broad band of carpeting over the deck surface covering the boards and the gaps between the boards would be unsatisfactory in that the carpet would inhibit the benefit of easy drainage of water and the passage of debris between the boards. Such a wide swath of carpet over individual boards would also create an unpleasing aesthetic effect as grooves or lines appear across the carpet. To cover each board individually would require the installer to measure and cut each strip individually and then secure the strip to the board. This obviously requires intensive labor to measure and cut each strip accurately and then to securely attach the cut strips to each board. Most importantly, merely carpeting over pressure treated boards may not significantly reduce the exposure to potential carcinogens in the boards as typical carpeting is permeable.

Other attempts to form exterior coverings for boards have been made by generating pre-manufactured elements that can be simply applied to the deck boards with the elements having a width substantially equal to the boards to cover the upper surfaces of the boards while leaving the spaces between the boards open for the escape of water and debris. However, these elements are rigid members that form a rigid barrier surface over the decking. Such a rigid member does not conform to boards that are warped or otherwise irregularly shaped. Further, such rigid coverings are expensive and costly to install.

There is a need for a product that will securely cover and/or seal the surface of treated lumber. To ensure secure attachment, the covering would need to accommodate dimensional changes due to expansion and contraction of the wood and conform to existing warping of boards. It would be desirable to provide a product that satisfactorily covers a deck to seal or refurbish the exposed surface while maintaining a reliable connection in an exterior environment at a reasonable cost. Additionally, there is a need for a product that can adapt to different shaped structures, such as railings or posts. However, no suitable arrangement has been provided in the prior art for secure and accurate attachment of covering material to exterior wood or wood-like building elements in an efficient and low cost manner.

### BRIEF SUMMARY OF THE INVENTION

An aspect of embodiments of the invention relates to a composite covering strip that is suitable for exterior use, especially on decks, that provides an impermeable barrier over a surface of a treated boards.

Another aspect of embodiments of the invention relates to a composite covering that has an adhesive tack and then forms a mechanical bond with the surface that is covered to securely interlock the covering to the surface.

A further aspect of embodiments of the invention relates to a composite covering that has a moldable layer that conforms and mates with the surface to which the covering is adhered.

An additional aspect of embodiments of the invention relates to a method of installing or instructing installation of a composite covering that has an adhesive surface on one side covered by a removable release sheet that has a positioning mechanism. The positioning mechanism can be a relatively narrow elongated positioning strip formed as part of the release sheet and/or printed indicia that is visible on either side of the composite covering.

The invention is directed to a covering strip that has the following qualities. The outer surface of the covering strip can provide a durable and slip resistant surface that is also aesthetically pleasing. The interior layer of the covering strip can provide a barrier that is completely impermeable, thus offering protection from treated surfaces, such as treated lumber. The lower layer of the covering strip can be formed as a moldable layer that flows and fills voids in irregular, existing surfaces of boards to provide a mechanical bond with the board. The lower layer can have adhesive properties to adhere to the surface of the board as well and can be formed as a hydrophobic, homogeneous, sealing layer. The covering strip can be provided with a release sheet that allows the covering strip, which has a lower layer with adhesive properties, to be handled and installed with ease. The release sheet can be configured to assist in placement and proper installation to effect a secure attachment between the covering strip and an existing, irregular surface.

The invention is directed to a covering for use on an exterior surface, comprising a fibrous layer having a back surface; an adhesive layer formed on the back surface of the fibrous layer; an impermeable barrier layer secured to the back surface of the fibrous layer with the adhesive layer; a moldable layer applied to the impermeable barrier layer and having a bottom surface with an adhesive property; and a release sheet releasably secured to the bottom surface of the moldable layer. The fibrous layer, the adhesive layer, the impermeable barrier layer, the moldable layer and the release sheet form a flexible composite covering strip that affixes and conforms to an exterior surface to which the covering strip is applied.

The moldable layer may applied at a coating weight of at least about 185 grams per square meter and a thickness of between 10-20 mils. The barrier layer may be foil. The foil may be carried on a polyester film.

The release sheet may be formed of multiple strips that are separately removable from the covering strip and may include a separate central release strip. The release sheet may have free edges that extend beyond the fibrous layer and moldable layer to provide a grasping surface at edges of the composite covering strip.

The release sheet may carry indicia indicative of the direction of the pile of the outer, fibrous layer. The indicia may also include installation directions and other information. The indicia may be carried on either side of the release sheet. The indicia may be visible from the bottom of the composite strip or may be disposed on the edges of the release sheet to be visible from the top of the composite strip.

The covering of the invention may be combined with a board of treated lumber, wherein the composite strip is applied to a surface of the board and forms an impermeable bond with a surface of the board of treated lumber to create a dermal barrier.

The invention is also directed to a flexible surface covering for use on treated lumber comprising an outer layer, an adhesive layer, an intermediate impermeable barrier layer, an moldable layer, and a release sheet releasably secured to the moldable layer.

The invention is additionally directed to a treated lumber covering, comprising an elongated carpet strip with a back surface having a foil laminated thereto and a thick adhesive layer applied to the foil at a thickness in the range of about 10-20 mils to form a moldable surface with an adhesive tack for attachment to the treated lumber.

The invention is further directed to a method of forming a barrier on a surface of treated lumber, comprising the following steps: providing a flexible composite strip formed of a fibrous layer, an adhesive layer, an impermeable barrier layer, a moldable layer with an adhesive property, wherein the moldable layer is applied at a basis weight of at least about 185 grams per square meter, and a release sheet releasably secured to the moldable layer; removing at least a portion of the release sheet to expose at least a portion of the moldable layer; and, applying the composite strip to the surface of the treated lumber to form an adhesive bond and a mechanical interlock between the composite strip and the surface of the treated lumber.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is a top plan view of deck section with the covering strip applied and being applied thereto;

FIG. 2 is a side perspective view of the covering strip in a package roll;

FIG. 3 is an enlarged side view in cross section of the covering strip;

FIG. 4 is an enlarged side view in cross section of the covering strip applied to the deck as in FIG. 1;

FIG. 4A is an enlarged portion of FIG. 4 showing a detail of the interface between the covering strip and a board;

FIG. 5 is bottom view of the covering of FIG. 3 showing a release sheet configuration for the covering strip in accordance with an embodiment of the invention;

FIG. 6 is an enlarged side view in cross section of edging applied to an end of a covered board in accordance with an embodiment of the invention; and

FIG. 7 is a perspective view of a play set in accordance with one possible design with the invention applied thereto.

In the drawings like reference numerals indicate corresponding parts in the different figures.

### DETAILED DESCRIPTION OF PREFERRED EMBODIMENTS

This invention is directed to a surface covering in the form of a strip particularly suited for covering boards, also referred to as planks or decking, in an exterior environment or an environment subject to exposure to the elements. The invention is particularly suited for boards made of wood, i.e. lumber, which tend to have irregular surfaces and typically exhibit warping and irregularities along their length. In the most preferred embodiment, the invention is used on treated lumber to provide a protective barrier over the surface of the treated lumber that could come into contact with a person.

However, the invention may also be used on plastic or plastic composite boards to provide a non-slip surface. Accordingly, this invention may be used on household decks, docks, wooden walkways, porches, play sets or other such structures. For purposes of simplicity, the term deck used herein is intended to refer to any structure formed of boards. Of course, the surface covering in accordance with this invention may also be used on any other type of surface desired to be covered with a fixed, durable covering, especially a barrier covering.

The covering strip in accordance with this invention is specifically designed to seal to the surface of treated lumber in existing structures to minimize human contact with this surface. In addition, the covering strip facilitates refurbishing any exposed surface. In a preferred form, as discussed in detail below, the covering strip is supplied in easily handled packages, such as rolls or boxes, for a homeowner or professional installer to use. However, it is also possible to supply pre-covered boards as building elements for such structures.

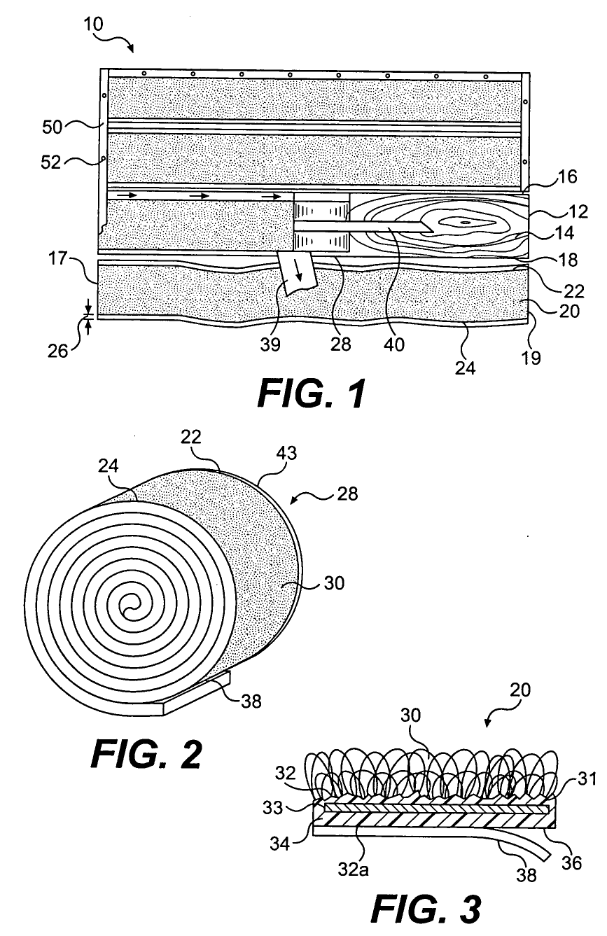

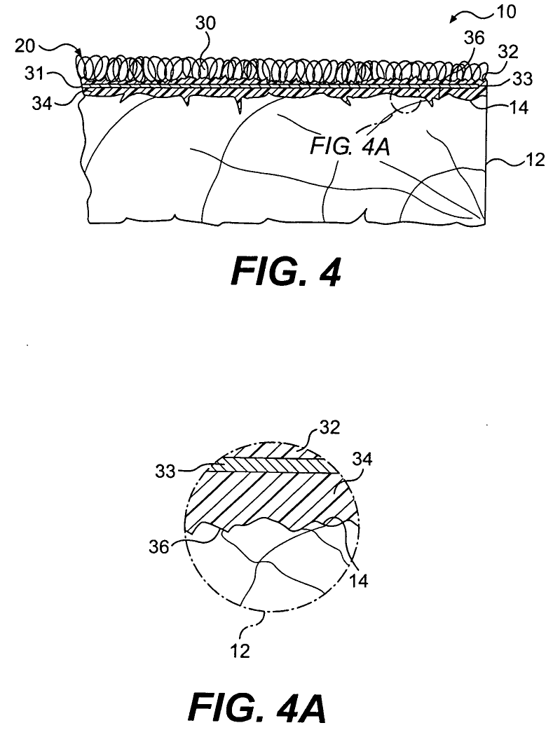

Referring to FIG. 1, a deck 10 suitable for use with this invention is illustrated. The deck 10 is formed of a series of slightly spaced elongated boards 12, as is known. As the deck 10 is outside, the spacing facilitates drainage and allows detritus to be easily removed. Each board 12 has an exposed surface 14, which in this case is an upper, horizontal surface, and an underneath or lower surface (seen in FIG. 4). The board 12 has opposed sides 16 and 18 that define a width of the exposed surface 14 and has ends 17 and 19 that define a length. Obviously, the length of each particular board 12 will vary according to the particular deck design. While the width can also vary, typically commercially available deck boards 12 are provided in 2×12 nominal widths, which actually measure approximately between 1½ by approximately 11½ inches, or 5/4×6 nominal widths, which actually measure about 1⅛ by 5½ inches. Obviously the size of conventional boards in European and Asian countries would differ slightly.

Each board 12 is nominally rectangular in cross-section and relatively straight in its elongate direction. However, as readily recognized by those of ordinary skill with lumber, many deck boards 12 are warped either prior to installation or become warped after installation, as the lowermost board 12 illustrated in FIG. 1 shows in a schematic sense. Of course, as recognized by those of ordinary skill in the art of building, lumber can warp in each of the dimensions.

A covering strip 20 is applied to the exposed surface 14 of the board 12. The covering strip 20 has opposed edges 22 and 24 along its length and has a predetermined width defined between the edges 22 and 24. The predetermined width can obviously vary, but is preferably established to be about the width of the exposed surface 14 of a typical board 12.

It is also possible to form the width of the covering strip 20 slightly less than the board 12, which allows the covering strip 20 to lay on the relatively flat exposed surface 14 and not overlap onto the typically rounded edges that lead to sides 16 and 18 of the board 12. It is also possible to form the width of the covering strip 20 the same width or slightly larger than the board 12 to allow the covering strip 20 to slightly overhang the rounded edges of sides 16 and 18 of the board 12.

For standard deck boards 12 that are 5/4×6 nominal, an appropriate width for the covering strip 20 is about 5¼ inches or less, preferably no more than 5⅜ inches and no less than 5 inches. For other deck boards 12 that are 2×12 nominal, an appropriate width for the covering strip 20 is about 11¼ inches or less. By this configuration, when the covering strip 20 is applied to the exposed surface 14 of the board 12 a small gap 26 is formed on either side of the covering strip 20, which is described in detail below. Obviously, various widths can be used, including widths suitable for covering steps (2×10 nominal boards) and 2×4 nominal boards, for example. The dimensions provided herein are intended to be examples of suitable widths. Of course, the covering strip could be made in any size depending on the desired application.

The covering strip 20 is preferably provided as an elongated strip, which can be any length, but is preferably a predetermined length that would be manageable when handled by an installer. An example of a suitable length would be 350 feet or less, which would weigh about 32 pounds or less. Of course, any length can be provided, for example 25 feet or less for smaller applications. The covering strip 20 could also be provided in other configurations, such as rectangles, etc. For ease of handling and efficient shipping and storage, the covering strip 20 is preferably supplied in a roll 28, as seen in FIG. 2. The roll 28 is easily packaged, prevents wrinkling of the covering material, and facilitates installation.

Referring to FIG. 3, the covering strip 20 is formed as a composite including an outer fibrous layer 30, which may be a fibrous material commonly used in floor covering applications. The fibrous layer 30 is generally formed in a felting-type process which forms a layer of sufficient thickness to provide an attractive underfoot feel and anti-slip properties. The fibrous layer 30 may be stitch bonded, integrally maintained by a bonding agent, or a layer of fibers that are basically attached and supported to a support layer. The fibrous layer 30 could also be formed as a tufted product formed through a backing mesh. It is contemplated that the outer layer 30 may be formed by any conventional carpet making process, including needle punching, tufted, or weaving.

In a preferred embodiment, for example, the fibrous layer 30 may be made or formed of extruded polypropylene fibers that are carded and then formed in a needle punching operation. Such a manufacture resists fraying and provides a flexible strip that that can flex laterally. The covering strip 20 should be flexible, especially in a side to side direction, and may have some elasticity. As is known, the fibrous layer 30 can be treated for fade resistance for exterior use, with for example UV (ultraviolet) protection.

The back surface 31 of the fibrous layer 30 provides integrity to the fibers and preferably includes a treatment or coating. Ideally, the backing or back surface 31 is thin or integral with the fibrous layer 30 so that an adhesive layer 32, discussed below, can mechanically interlock with the fibrous layer 30. The back surface 31 may be formed of a coating of SBR (styrene butadiene rubber), EVCL (ethyl vinyl chloride), vinyl, or acrylic, for example, with various additives if desired, such as clay. If the fibrous layer 30 is formed on a mesh, generally a coating of latex is applied directly onto the mesh. In the preferred embodiment, the fibrous layer 30 is provided with a coating of layer or acrylic, for example. The back surface 31 coating can be applied at various weights, including two, four and eight ounce coatings. When coated, the back surface 31 adds stability to the covering strip 20 and can increase performance by reducing adhesive penetration as discussed below.

It is noted, however, a coating layer may create undesirable bonding qualities between the adhesive 32 and the back surface 31 in some applications. Therefore, in one embodiment, the back surface 31 is merely the underside of the fibers. The underside may also be singed. It is preferred that the back surface 31 not be formed of a foam backing layer or a porous material as is common in interior carpeting as this tends to become water logged and would disintegrate upon exposure to the elements.

As can be appreciated from FIGS. 3 and 4, the back surface 31 has an uneven, rough or irregular surface. Even with a coating or treatment, the back surface 31 may tend to remain uneven as the coating or treatment will follow the surface of the fibers.

The fibrous layer 30 is formed substantially in minimum thickness to achieve an acceptable underfoot layer. Such a weight can lie in the range of 10 oz/sqyd up to 30 oz/sqyd, for example. Of course, different thicknesses may be selected based on the actual material used for layer 30 and for the desired durability and intended geographic installation.

While the covering strip 20 preferably includes an upper surface of fibrous material, it can be formed of other materials which are of a character suitable for the upper surface of a floor covering material. Any material that renders the surface pleasant to touch and resistant to slip would be suitable. Other types of resilient material can therefore be used. It is also contemplated that materials providing a barrier could be used. For example, the upper surface could be made of vinyl.

An impermeable barrier layer 33 is laminated to the back surface 31 of the fibrous layer 30 by an adhesive layer 32. Preferably, the barrier layer 33 is adhered to the back surface 31 by an adhesive layer 32 having a coating weight of about 100-300 gsm, preferably about 200 gsm. The adhesive layer 32 can be PSA or non-PSA. The adhesive layer 32 may or may not be a hot melt.

In a preferred embodiment, the adhesive layer 32 is a non-PSA, for example a polyethylene, copolymer, EAA, or EVA that locks the fibrous layer 30 to the barrier layer 33 and does not degrade even when exposed to high heat. It is also beneficial to use a high viscosity adhesive at a thickness of 5 to 24 mils, preferably 10-20 mils, with a back surface 31 having a 4 to 8 ounce coating to discourage penetration of the adhesive layer 32 into the fibrous layer 30 while maintaining the adhesive properties in extreme climates.

However, any suitable adhesive could be used. It is preferred that hydrophobic adhesive be used to prevent water contaminating the bond with the back surface 31. Of course, any method of attaching the barrier layer 33 to the back surface 31 of the exterior surface layer 30 can be used.

The impermeable barrier layer 33 can be made of any impermeable material that would prevent or minimize contact with and/or transmission of substances, such as carcinogens, from the exposed surface 14 of the treated boards 12. The barrier layer 33 should also be flaccid or flexible to allow for installation and to avoid breaking or cracking during storage and installation. A preferred material for barrier layer 33 is a foil, such as an aluminum foil that is entirely moisture and gas impermeable and provides a complete shield. A suitable foil would be 0.00035 inch (8 microns) thick aluminum, but could be in the range of 0.25 to 0.90 mils thick.

The foil 33 may be applied directly to back surface 31 of the fibrous layer 30 with adhesive 32, for example, or may be applied as a foil laminate, such as aluminum supported on a plastic substrate, such as 0.5 mil polyester or Mylar. In a preferred embodiment, the foil is carried on a polyester film that is about 1-5 mils thick that allows the material to stretch and eases handling during manufacture. It is also contemplated that suitable materials for the barrier layer 33 can include metalized film or polyvinylidene chloride (pvdc) film, for example. A plastic substrate also would ensure a moisture barrier and, if desired, could be used without the foil.

As seen in FIG. 3, a thick layer of moldable material 34 is formed onto the barrier layer 33 and functions as an attachment layer. The back surface 31 of the fibrous layer 30 has no intervening layer, such as a foam layer, and is at most coated or treated. Thus, the barrier layer 33 can be laminated to the fibers of the fibrous layer 30 or the coating on the back surface 31 via the adhesive layer 32, which results in the moldable material 34 being effectively directly attached to the barrier layer 33 and the fibrous layer 30.

As seen in FIG. 3, the barrier layer 33 can be encapsulated in the covering strip 20, if desired. In this case, the barrier layer 33 is provided slightly narrower in width than the fibrous layer 30. The adhesive layer 32 then extends beyond the edges of the barrier layer 33. When the moldable material 34 is formed onto the barrier layer 33, the edges of the moldable material 34 bond with the edges of the adhesive layer 32, thus encasing the barrier layer 33. This securely seals the barrier layer 33 into the composite strip 10 and also prevents any exposure to UV rays or moisture, which could degrade the barrier layer 33.

The moldable layer 34 is preferably made of a pressure sensitive adhesive (PSA) that is a hot melt, meaning it is applied at 100% solids. Suitable adhesive compositions are available from many different manufacturers and can be used as a hot melt adhesive. The application techniques can vary depending on the particular adhesive composition, but one effective method is for the adhesive to be die coated and, if desired, treated with pressure and/or vacuum to enhance physical penetration of the fibrous layer 30. Other suitable methods known to those of ordinary skill in the art are also possible, such as spraying, extrusion, or other methods of coating. It is also possible to apply the adhesive layer 32 for the barrier layer 33 by laying a strip of adhesive material on the back surface 31. Similarly, the moldable layer 34 could be applied to the barrier layer 33 in the same way. It is preferred that hydrophobic adhesive be used to prevent water contaminating the bond between the adhesive and board.

Any type of moldable or malleable material application is suitable as layer 34 as long as it forms a strong, yet flexible integral structure including a fibrous layer 30 laminated to a barrier layer 33 and a moldable layer 34 directly bonded thereto and an outer surface having an adhesive quality. As noted above, the moldable layer 34 may be a single material, such as a PSA. The moldable layer 34 may also be a composite layer formed of a malleable material, such as silicon caulking, green rubber or other flowable material, with an inherent adhesive property or an adhesive layer applied to the outer surface. If the moldable material is not inherently adhesive, it may be desirable to apply the moldable layer 34 to the barrier layer 33 by an adhesive or other secure attachment technique. The viscosity of the moldable material may also be varied to affect penetration or wetting into the surface 14 of the board 12. Lowering the viscosity, increases the wetability (tack) of the adhesive, thereby allowing it to penetrate deeper into the surface 14 of the board 12. The moldable material functions as a waterproof layer based on its composition and/or thickness. It is preferred that the material be free of voids.

As best seen in FIGS. 3 and 4, the adhesive layer 32 has a bottom surface 32a, which can be smoothed by the application technique, if needed. This results in a variable thickness of adhesive layer 32 that ranges from the peaks and valleys of the uneven back surface 31 of the fibrous layer 30 to the smooth bottom surface 32a of the adhesive layer 32. Since the adhesive layer 32 with the barrier layer 33 provides an even surface to which the moldable layer 34 can be applied, the moldable layer 34 can be provided with a uniform thickness.

As noted above, in this invention, the moldable layer 34 is applied as a thick layer. The minimum thickness measured between the barrier layer 33 and the bottom surface 36 of the moldable layer 34 is preferably at least 5 mils so as to provide sufficient thickness of adhesive material to obtain complete coverage to allow molding of the covering strip 20 to the exposed surface 14 of the board 12, as described in more detail hereinafter. The range of preferred thickness of the moldable layer 34 is between about 5 mils and 24 mils, more preferably 10 mils-20 mils. Another method of measuring the moldable layer is the applied basis weight, coating weight or amount, as the thickness can vary depending upon application techniques The preferred coating weight or amount of moldable material is at least about 185 gsm, preferably in a range of approximately 185-600 gsm, and most preferably about 300-500 gsm, applied to the barrier layer 33. These values are based on use of a PSA.

It is contemplated that with different molding materials, application techniques, and environments that different volumes, coating weights, or amounts could be successfully used as long as the material has the ability to mold to the irregular surface of the boards to form a permanent bond. For example, it is contemplated that a coating weight of about 100 gsm given the appropriate material could be used, especially in climates that do not experience freeze/thaw cycles. It is also contemplated that in certain applications, strips of moldable material may be used rather than a solid layer.

FIG. 3 also shows a release sheet 38 applied over the bottom surface 36 of the moldable layer 34. The release sheet 38, which is also called a release liner, can be formed of any releasable sheet material that is easily pulled from the bottom surface 36 of the moldable layer 34. A suitable material is silicone coated polyester film. However, other materials may be used, including films such as high density polyethylene, polypropylene, polyolefins, or silicon coated paper. A preferred material is a silicone coated polyester sheet about 1-2 mils thick. The important features of the sheet 38 are that it releases reliably from the adhesive surface of the moldable layer 34 and avoids tearing so that it is easy for an installer to use.

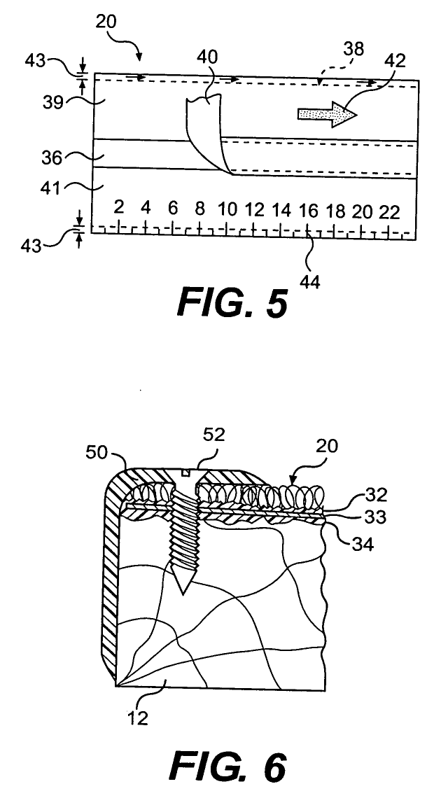

The release sheet 38 may be provided as a single sheet that spans the width of the strip 20. It may also be provided as a series of sheets the width of the covering strip 20 arranged along the length of the covering strip 20 so that as the covering strip 20 is applied to a board 12 progressive lengths of the moldable layer 34 may be exposed. As seen in FIG. 5, the outer edges, or at least one edge, of the release sheet 38 preferably extend beyond the edges of the covering strip 20 with a free edge 43. This creates a grasping surface to effect removal of release sheet 38 as discussed below.

In a preferred embodiment illustrated in FIG. 5, the release sheet 38 is formed in separate longitudinal strips 39, 40, 41, with a relatively central strip 40 extending the length of the covering strip 20. The longitudinal strips 39, 40, 41 are arranged side by side across the width of the bottom surface 36 of the moldable layer 34. The central strip 40 can be relatively narrow, such as an inch or less. Preferably, the strips 39, 40, 41 are arranged in an overlapping relationship, as shown in FIG. 5, with the central strip 40 overlapping the underlying side strips 39 and 41. However, while the overlap assists in removing the strip 40 and prevents the exposure of the moldable layer 34 from between adjacent strips, it is not necessary.

The strips of release sheet 38 may be applied to the moldable layer 34 as pre-cut strips or can be applied as a single sheet and then separated, by laser for example. Of course, any number of longitudinal strips could be used, including two or four or more. Further, any configuration of strips could be used. For example, a relatively narrow strip, similar to strip 40, could be used at one edge of the moldable layer with a larger strip covering the remaining width. The significance of at least one generally centrally located strip 40, and in general at least one positioning strip, is discussed below.

The central release strip 40 is designed to be used as an initial tack area during installation. The release strip 40 can be removed wholly or partially from the length of the covering strip 20 to be applied onto the deck board 12 with minimal pressure providing an initial tack area to center and accurately position the covering strip 20 on the exposed surface 14 of the board 12 while the remaining part of the covering strip 20 remains unconnected due to the presence of the release strips 39 and 41. After the covering strip 20 is properly applied onto the board 12 at the required position with the edges 22 and 24 directly aligned with the sides 16 and 18 of the exposed surface 14 of the board 12, as seen in FIG. 1, the release strips 39 and 41 can be removed by grasping the free edges 43 of the particular release strip and peeling the release sheet 39 or 41 away to allow the adhesive surface of the moldable layer 34 to contact the exposed surface 14 of the board 12.

Thus, complete adhesion to the board 12 across the full width of the covering strip 20 is only effected after the covering strip 20 is securely positioned and tacked in place with the central portion of the adhesive surface of the moldable layer 34 exposed by release strip 40. The same approach can be used with a narrow strip along one side which is applied first, leaving the remainder of the release strip to be removed later.

This method of installation is especially useful in a situation where the deck boards 12 are warped, as shown schematically in FIG. 1. Since only the central area of the adhesive surface of the moldable layer 34 is exposed and the covering strip 20 has been manufactured with flexibility in its lateral direction, it is possible to steer or bend the covering strip 20 to follow the warped curvature of the board 12 to precisely lay the covering strip 20 in close conformance with the edges 16 and 18. Following the initial tacking by removing the release strip 40, complete bonding of the slightly bowed covering strip 20 can be effected by full release of the release sheet 39, 41.

This method also avoids the common occurrence of the covering strip 20 wrinkling during installation of adhesive coated material. As the adhesive can be quite aggressive, once the covering strip 20 is laid down, it is difficult to pull it up to straighten wrinkles that may occur during application. Additionally, pulling up the entire adhered covering strip 20 will pull up particles of the board 12 and thus contaminate the adhesive layer 34 with particles of board and dirt and compromises the adhesive qualities. By adhering the covering strip 20 in place with minimal pressure using a small strip of adhesive under release strip 40, the covering strip 20 can be repositioned and wrinkles can be worked out by either manipulating the remainder of the non-adhered strip 20 or by merely pulling up the small centrally adhered portion. This method can also be used to install other adhesive based materials.

Also shown in FIG. 5, the release sheet 38 may carry certain indicia and information. Carpeting has pile that extends in a particular direction. It is important for aesthetic purposes to orient strips or pieces of carpeting so that the pile extends in the same direction. Otherwise, if the pile extends in opposite directions, the various pieces will appear to be a different color due to the reflection of the light, which can result in a striping effect. The release sheet 38, therefore, can carry indicia 42, in this case an arrow, indicating the direction of the pile. By this, an installer can ensure that the pile of each strip 20 extends in the same direction. Alternatively, the installer can create a pattern based on the different directions of the pile using the indicia 42. The indicia 42 indicating pile direction may also be disposed on the free edge 43 so that it is visible from the top surface or fibrous side of the composite strip. By this, the installer can confirm the pile direction without turning the covering strip 20 over.

The release sheet 38 can also be pre-printed with measurements 44 to assist in cutting lengths from the covering strip 20 during installation. For example, when resurfacing a deck 10 that is 15 feet wide, it may be useful to pre-cut about 15 foot lengths from the roll 28 to ease installation. The pre-printed measurements 44 make it very easy for the installer to make accurate cuts and avoid mistakes in measuring. Of course, any type of information may be provided on the release sheet 38, including installation instructions and logos. The release sheet 38 may be printed with the indicia or the indicia may be formed during manufacture of the sheet 38. As noted above, the indicia may be formed on either surface of the release sheet 38 so that it is visible from either or both directions.

To assemble the covering strip 20 onto a deck 10, a length of the covering strip 20 is cut from the roll 28 or the entire roll 28 is placed on one end of the board 12 on top of the exposed surface 14. For ease and efficiency of installation, it is preferred that the roll 28 be provided with the release sheet 38 facing outwardly. If a length is cut from the roll 28, the length can be rolled into a smaller roll to assist in handling the covering strip 20. Starting at one end of the board 12, the covering strip 20 is positioned between the sides 16 and 18 of the exposed surface 14 of the board 12, preferably with a small gap 26 on each side. The end of the covering strip 20 may be located at the edge 17 of the board or slightly overlapping the edge 17 if desired. The release sheet 38 is then removed to expose the bottom surface 36 of the adhesive surface of the molding layer 34. In the case of a central release strip 40, only the central release strip 40 is removed to enable the installer to adhere a portion of the covering strip 20 in place.

Additional length of the covering strip 20 is rolled out or otherwise positioned on the board 12 while adhering the central area in place. By this, the covering strip 20 may be steered along the board 12 laterally shifting and conforming to the variations in the board 12. When the entire length of covering strip 20 is tacked in place and the installer is satisfied with the position and the appearance, the free edges 43 of the remaining release sheets 39 and 41 are grasped and peeled away on either side to secure the entire width of the covering strip 20 to the exposed surface 14. Pressure should be applied to the entire surface of the covering strip 20 along the length of the covered board 12 to ensure intimate contact between the adhesive surface of the moldable layer 34 and the exposed surface 14 of the board 12. This procedure is followed for each board 12. If desired, the covering strip 20 could also be applied across its entire width progressively along the length of the board 12.

FIG. 1 illustrates this process showing a board 12 with the covering strip 20 secured to the first half of the length of the board 12 while the central release strip 40 is torn away for tacking the leading edge down. One of the side release strips 39 is shown peeled back to secure the side edges of the covering strip 20. Preferably, the side release strips 39, 41 are peeled back after the entire length of the covering strip 20 is applied to the board 12.

The moldable layer 34 is of sufficient thickness to conform and provide a secure attachment to the exposed surface 14 of the board 12. This exposed surface 14 has inherent recesses, cracks and other discontinuities or distortions as is common with lumber, as schematically show in FIGS. 4 and 4A. It should be well appreciated that wood is not a homogenous material so that many such cracks and imperfections are present. Even with the absence of cracks, there are other discontinuities formed by the grain of the wood and by cut marks formed in the wood. Weathering also creates additional texture, cracking and discontinuities on the surface. Thus the exposed surface 14 of boards 12 is highly variable both in height and line due to twisting or warping and on a small scale by the cracks and other discontinuities described above.

The moldable layer 34, particularly the pressure-sensitive adhesive of the preferred embodiment, is selected to provide a high level of adhesion so that the covering strip 20 initially securely bonds to the exposed surfaces 14 of the deck 10 or other structure. The tack or wetability of the adhesive is sufficient that it applies adhesive contact across substantially the full width of the exposed surface 14 of each board 12, but does not necessarily engage into individual cracks in the wood immediately upon contact. The initial attachment is therefore provided by the aggressive action of the adhesive surface of the moldable layer 34. The layer 34 creates a bond between the barrier layer 33, which is bonded to the fibers of layer 30, and the exposed surface 14 of the deck 10. The covering strip 20 is sealed to the board 12 and also prevents moisture from penetrating between the fibrous layer 30 and the board 12. More importantly, the covering strip 20 seals the surface 14 of the board 12 and covers the surface 14 to prevent or minimize potential contact with and/or transmission of substances, such as carcinogens, from the treated boards 12.

In fact, over time, due to various factors, the tack of the adhesive surface 36 of the moldable layer 34 may deteriorate. The thickness of the moldable layer 34 is therefore designed so that over time the material is molded by additional pressure of normal exterior use into the exposed surface 14 of the wood so that it engages into cracks and other distortions in the board 12 to provide a secondary mechanical bond caused by the molding action. Thus, even if the tack of the moldable layer 34 has deteriorated, a mechanical interlock remains due to the molding or flow of the moldable layer 34 into the discontinuities in the exposed surface 14. The moldable layer 34 thus mates with the surface 14 and provides a secure attachment in the long term between the covering strip 20 and the board 12.

As discussed above, the preferred minimum applied weight or amount of moldable layer 34 is at least about 185 gsm up to about 600 gsm, most preferably about 300-500 gsm. Expressed in another way, the preferred minimum thickness of the moldable layer 34 is about 5 mils and can range in thickness up to about 24 mils. This amount of material provides sufficient material to cause the above molding effect. This amount also ensures that there is bonding upon the initial application of the covering strip 20 across its full width onto surface 14 of the board 12 taking into account possible distortion of the board 12 caused by warping and other larger scale discontinuities or variations.

In addition, use of a pressure sensitive adhesive material provides a resultant plastic material that is relatively moldable allowing the moldable layer 34 to conform to and engage the cracks and other discontinuities in the surface 14 of the board 12. Thus, it is important that no voids of any substantial size are formed during the initial application. Such voids between the covering strip 20 and the exposed surface 14 can trap moisture or contaminants, which will expand in a freeze/thaw cycle. Expansion rapidly increases the separation between the components that can cause a typical breakdown of adhesion over the covered area. The complete coverage of the moldable layer 34 in accordance with this invention can ensure that voids are not created during application.

An optional final step in assembly is to add an edge trim piece 50, seen in FIGS. 1 and 6. Exposed edges of the deck 10 either at the sides or ends or on a step are typically easily scuffed or torn in use. While the moldable layer 34 set forth above provides sufficient adhesion to effectively maintain the main body of the covering strips 20 in engagement with the exposed surfaces 14 of the deck 10, it is in some cases insufficient to tolerate scuffing, tearing, or lifting caused by the engagement of feet or other parts of persons or objects pulled across the surface. Thus, an exposed edge of the covering strip 20 can be lifted, acting to slightly break away the connection to the board 12 at the edge. Once this has occurred, further lifting can continue until the remainder of the connection under the main body of the strip 20 breaks down.

To prevent the board surface 14 from becoming exposed to provide a pleasing finished appearance, an edge trim piece 50 can be applied at the edges 16, 17, 18, or 19, as seen in FIG. 1. The trim piece 50 can be formed as any shape, but is preferably an angle piece that folds over both exposed surfaces at the corners of the board 12. The piece 50 can be secured to the board with a fastener 52, such as a screw, in a countersunk aperture, for example. If desired, the piece 50 can be coordinated in appearance with the fibrous layer 30 to present a pleasant uniform appearance. The piece 50 may be formed of plastic, metal, wood or any material suitable for high traffic, exterior use. By this, the whole area of the covering strip 20 at the exposed edge of the deck 10 is protected by the trim piece 50 to prevent the edge of the covering strip 20 from being lifted. It is noted that the trim piece 50 is entirely optional and the adhesive layer 34 retains the remainder of the strip 20 in place over the main area of the covering strip 20 on the exposed surface 14 of the board 12.

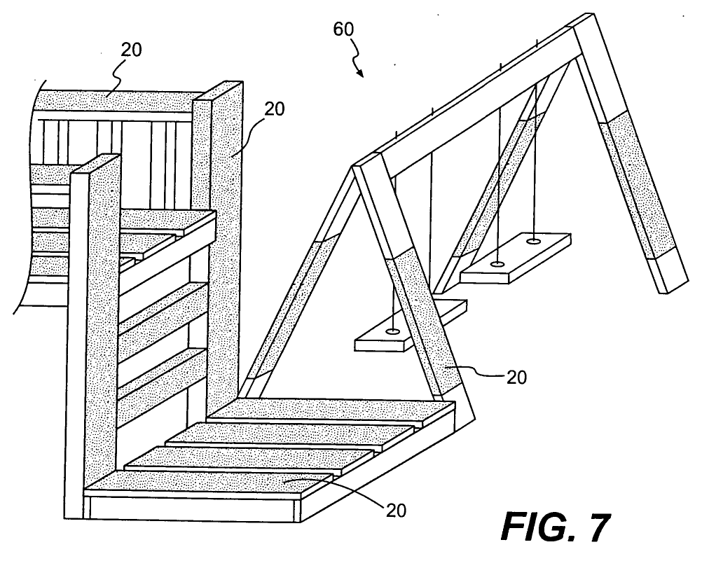

FIG. 7 shows an example of a play set 60 made of treated lumber with selected portions of the play set 60 covered with the covering strip 20. As seen, the railings, deck surfaces and upright supports have the covering strip 20 adhered thereto to cover portions that would typically be touched by a child's hand during play. Since the barrier layer 33 creates an impermeable dermal barrier, by covering these highly handled areas, contact with and exposure to treated lumber, such as CCA treated boards, can be significantly reduced.

Various modifications can be made in my invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

1. A covering for use on an exterior surface, comprising:
a fibrous layer having a back surface;
an adhesive layer formed on the back surface of the fibrous layer;
an impermeable barrier layer secured to the back surface of the fibrous layer with the adhesive layer;
a moldable layer applied to the entire impermeable barrier layer and having a bottom surface with an adhesive property, wherein the moldable layer is applied at a coating weight of at least about 185 grams per square meter; and
a release sheet releasably secured to the bottom surface of the moldable layer,
wherein the fibrous layer, the adhesive layer, the impermeable barrier layer, the moldable layer and the release sheet form a non-rigid composite covering strip that affixes and conforms to an exterior surface to which the covering strip is applied.

2. The covering of claim 1, wherein the barrier layer is foil.

3. The covering of claim 1, wherein the barrier layer is foil supported on a plastic film.

4. The covering of claim 1, wherein the barrier layer is encapsulated between the adhesive layer and the moldable layer.

5. The covering of claim 1, wherein the barrier layer has a first width and the fibrous layer has a second width, wherein the second width is greater than the first width.

6. The covering of claim 1, wherein the composite strip is elongated with a predetermined length and has a predetermined width, the predetermined width being less than the predetermined length.

7. The covering of claim 6, wherein the predetermined width is less than twelve inches.

8. The covering of claim 6, wherein the predetermined length is at least 25 feet.

9. The covering of claim 1, wherein the moldable layer is formed of a hot melt adhesive.

10. The covering of claim 1, wherein the fibrous layer is a mat formed by needle punching.

11. The covering of claim 1, wherein the fibrous layer is tufted.

12. The covering of claim 1, wherein the fibrous layer is woven.

13. The covering of claim 1, wherein the fibrous layer is carpet.

14. The covering of claim 1, wherein the composite covering strip is packaged in a roll.

15. The covering of claim 1, wherein the release sheet is formed of a silicon coated material.

16. The covering of claim 1, wherein the release sheet has a separate central release strip.

17. The covering of claim 1, wherein the release sheet is formed as three release strips including a release strip on each edge and a middle release strip disposed between the release strips on the edges, wherein each release strip is separately removable from the moldable layer.

18. The covering of claim 17, wherein the middle release strip overlaps the release strips on the edges.

19. The covering of claim 1, wherein the release sheet has free edges that extend beyond the fibrous layer and moldable layer to provide a grasping surface at edges of the composite covering strip.

20. The covering of claim 19, wherein the free edges include an indicia that indicates direction of pile of the fibrous layer.

21. The covering of claim 1, wherein indicia is formed on the composite covering strip that is visible with the release sheet in place.

22. The covering of claim 1, wherein the release sheet is formed of plural sheets.

23. The covering of claim 22, wherein the plural sheets of the release sheet include at least one positioning strip having a width less than at least one of the other sheets.

24. The covering of claim 1, wherein the moldable layer is applied at a coating weight of between about 185 and 600 grams per square meter.

25. The covering of claim 1, wherein the moldable layer is applied at a coating weight of between about 300 and 500 grams per square meter.

26. The covering of claim 1, wherein the moldable layer has a thickness of between about 10-20 mils.

27. The covering of claim 1, in combination with a board of treated lumber, wherein the composite strip is applied to a surface of the board and forms an impermeable bond with a surface of the board of treated lumber.

28. A treated lumber covering, comprising:
an elongated carpet strip with a back surface having a flaccid foil laminated thereto and a thick adhesive layer applied to the foil that forms a moldable surface with an adhesive tack for permanent attachment to the treated lumber that creates a dermal barrier.

29. The treated lumber covering of claim 28, wherein the thick adhesive layer is applied to the foil at a thickness in the range of about 10-20 mils.

30. The treated lumber covering of claim 28, wherein the thick adhesive layer is applied to the foil at a coating weight of between about 185 to 600 grams per square meter.

31. The treated lumber covering of claim 28, wherein the thick adhesive layer is pressure sensitive adhesive.

32. The treated lumber covering of claim 28, further comprising a release sheet removably secured to the moldable surface of the thick adhesive layer.

33. The treated lumber covering of claim 32, wherein the release sheet includes a positioning strip portion separable from the remaining release sheet that provides an initial tack area for the treated lumber covering.

34. The treated lumber covering of claim 32, wherein the release sheet carries indicia indicative of direction of pile of the carpet strip.

35. The treated lumber covering of claim 28, further comprising indicia indicative of direction of pile of the carpet strip.

36. A composite strip comprising:
a layer of a fibrous floor covering material having a fibrous front surface and a back surface;
an adhesive layer adhesively attached to the back surface of the fibrous layer;
an impermeable foil barrier layer which is secured to the back surface of the fibrous layer by the adhesive layer so as to substantially cover the back surface of the fibrous layer;
an attachment layer covering the foil barrier layer having a bottom surface with an adhesive property for attaching the fibrous floor covering material and the foil barrier layer to a support surface; and
a release sheet on the attachment layer which is arranged to be removed for attachment of the attachment layer to the surface,
wherein the foil barrier layer has a thickness less than 0.001 inch (one thousandth of an inch).

37. The composite strip according to claim 36 wherein the composite strip is elongate and rolled to form a supply roll.

38. The composite strip according to claim 36 wherein the attachment layer has the following properties:
it is water impermeable;
it is non-absorbent of water;
it is substantially incompressible in the thickness direction.

39. The composite strip according to claim 36 arranged so as to allow side to side flexibility thereof to allow bending of the layers to match a bowed treated wooden board.

40. The composite strip according to claim 36 wherein the impermeable layer is flaccid so as to provide no resistance to bending of the fibrous layer and the attachment layer from a rolled condition to a flat condition for attachment to a generally flat surface of a wooden board and to follow generally any undulations in the flat surface.

41. The composite strip according to claim 36 wherein the attachment layer has a coating weight per unit area of greater than 185 grams/sq meter.

42. The composite strip according to claim 36 the attachment layer has a coating weight per unit area of greater than 300 grams/sq meter.

43. The composite strip according to claim 36 wherein total material applied in the attachment layer and in between the barrier layer and the layer of fibrous floor covering material has a weight per unit area of greater than 300 grams/sq meter.

44. The composite strip according to claim 36 wherein total material applied in the attachment layer and in between the barrier layer and the layer of fibrous floor covering material has a weight per unit area of greater than 400 grams/sq meter.

45. The composite strip according to claim 36 wherein total material applied in the attachment layer and in between the barrier layer and the layer of fibrous floor covering material has a weight per unit area of greater than 600 grams/sq meter.

46. The composite strip according to claim 36 wherein the barrier layer is foil supported on a plastic film.

47. The composite strip according to claim 36 wherein the barrier layer is encapsulated between the adhesive layer and the attachment layer by an interconnection of the edges of the adhesive layer and the attachment layer at the edges of the barrier layer.

48. The composite strip according to claim 36 wherein the release sheet is divided into a plurality of release strip portions including a positioning strip release portion and a remaining strip release portion; said positioning strip release portion covering and defining a positioning portion of the attachment layer extending longitudinally along the strip which can be removed to expose the positioning portion for initial attachment of the composite strip to an elongate board; and said remaining strip release portion covering and defining a remaining portion of the attachment layer extending longitudinally along the strip which can be removed subsequent to the positioning strip release portion to expose the remaining portion for subsequent attachment of the composite strip to an elongate board.

49. The composite strip according to claim 48 wherein the remaining portion exposed by removing the remaining strip release portion is wider than the positioning portion exposed by removing the positioning strip release portion.

50. The composite strip according to claim 48 wherein the positioning strip release portion has a side edge which overlaps with and covers a side edge of the remaining strip release portion so as to define a free side edge portion which can be grasped during removal.

51. The composite strip according to claim 48 wherein the remaining strip release portion has an outer free edge that extends beyond the attachment layer to provide a free side edge portion for grasping during removal of the release sheet.

52. The composite strip according to claim 51 wherein the outer free edge that extends beyond the attachment layer carries markings indicative of a direction of pile of the layer of fibrous floor covering material.

53. The composite strip according to claim 48 wherein the positioning strip release portion is located between two remaining strip release portions, each remaining strip release portion positioned along a respective edge of the strip.

54. The composite strip according to claim 53 wherein the positioning strip release portion has two side edges each of which overlaps with and covers a side edge of a respective one of the remaining strip release portions so as to define free side edge portions for grasping during removal.

55. The composite strip according to claim 53 wherein each of the two remaining strip release portions has an outer free edge that extends beyond the attachment layer to provide a free side edge portion for grasping.

56. The composite strip according to claim 55 wherein the outer free side edge portion that extends beyond the attachment layer carries markings indicative of a direction of pile of the layer of fibrous floor covering material.

57. A composite strip comprising:
a layer of a elongate fibrous floor covering material having a fibrous front surface and a back surface;
an adhesive layer adhesively attached to the back surface of the fibrous layer;
an impermeable foil barrier layer which is secured to the back surface of the fibrous layer by the adhesive layer so as to substantially cover the back surface of the fibrous layer;
an attachment layer covering the foil barrier layer having a bottom surface with an adhesive property for attaching the fibrous floor covering material and the foil barrier layer to a support surface; and
a release sheet on the attachment layer which is arranged to be removed for attachment of the attachment layer to the surface,
wherein the barrier layer is flaccid.

58. The composite strip according to claim 57 wherein the composite elongate strip is rolled into a roll.

59. The composite strip according to claim 57 which is arranged so as to provide no resistance to bending of the fibrous layer and the attachment layer from a rolled condition to a flat condition for attachment to a generally flat surface and to follow by gravity generally any undulations in the flat surface.

60. The composite strip according to claim 57 arranged so as to allow side to side flexibility thereof to allow bending of the layers to match a bowed treated wooden board.

61. The composite strip according to claim 57 wherein the attachment layer has a coating weight per unit area of greater than 185 grams/sq meter.

62. The composite strip according to claim 57 the attachment layer has a coating weight per unit area of greater than 300 grams/sq meter.

63. The composite strip according to claim 57 wherein total material applied in the attachment layer and in between the barrier layer and the layer of fibrous floor covering material has a weight per unit area of greater than 300 grams/sq meter.

64. The composite strip according to claim 57 wherein total material applied in the attachment layer and in between the barrier layer and the layer of fibrous floor covering material has a weight per unit area of greater than 400 grams/sq meter.

65. The composite strip according to claim 57 wherein total material applied in the attachment layer and in between the barrier layer and the layer of fibrous floor covering material has a weight per unit area of greater than 600 grams/sq meter.

66. The composite strip according to claim 57 wherein the barrier layer is foil supported on a plastic film.

67. The composite strip according to claim 57 wherein the barrier layer is encapsulated between the adhesive layer and the attachment layer by an interconnection of the edges of the adhesive layer and the attachment layer at the edges of the barrier layer.

68. The composite strip according to claim 57 wherein the release sheet is divided into a plurality of release strip portions including a positioning strip release portion and a remaining strip release portion; said positioning strip release portion covering and defining a positioning portion of the attachment layer extending longitudinally along the strip which can be removed to expose the positioning portion for initial attachment of the composite strip to an elongate board; and said remaining strip release portion covering and defining a remaining portion of the attachment layer extending longitudinally along the strip which can be removed subsequent to the said positioning strip release portion to expose the remaining portion for subsequent attachment of the composite strip to an elongate board.

69. The composite strip according to claim 68 wherein the remaining portion exposed by removing the remaining strip release portion is wider than the positioning portion exposed by removing the positioning strip release portion.

70. The composite strip according to claim 68 wherein the positioning strip release portion has a side edge which overlaps with and covers a side edge of the remaining strip release portion so as to define a free side edge portion for grasping.

71. The composite strip according to claim 68 wherein the remaining strip release portion has an outer free edge that extends beyond the attachment layer to provide a free side edge portion for grasping during removal.

72. The composite strip according to claim 71 wherein the outer free edge that extends beyond the attachment layer carries markings indicative of a direction of pile of the layer of fibrous floor covering material.

73. The composite strip according to claim 68 wherein the positioning strip release portion is located between two remaining strip release portions each disposed along a respective edge of the strip.

74. The composite strip according to claim 73 wherein the positioning strip release portion has two side edges each of which overlaps with and covers a side edge of a respective one of the remaining strip release portions so as to define free side edge portions for grasping.

75. The composite strip according to claim 74 wherein each of the two remaining strip release portions has an outer free edge that extends beyond the attachment layer to provide a free side edge portion for grasping during removal.

76. The composite strip according to claim 75 wherein the outer free side edge portion that extends beyond the attachment layer carries markings indicative of a direction of pile of the layer of fibrous floor covering material.

77. A composite elongate strip comprising
a layer of a fibrous floor covering material having a fibrous front surface and a back surface;
an adhesive layer adhesively attached to the back surface of the fibrous layer;
an impermeable foil barrier layer which is secured to the back surface of the fibrous layer by the adhesive layer so as to substantially cover the back surface of the fibrous layer;
an attachment layer covering the foil barrier layer and having a bottom surface with an adhesive property for attaching the fibrous floor covering material and the foil barrier layer to a support surface; and
a release sheet on the attachment layer which is arranged to be removed for attachment of the attachment layer to the surface,
wherein the release sheet is divided into a plurality of release strip portions including a positioning strip release portion and a remaining strip release portion,
the positioning strip release portion covering and defining a positioning portion of the attachment layer extending longitudinally along the strip which can be removed to expose the positioning portion for initial attachment of the composite strip to an elongate board, and
the remaining strip release portion covering and defining a remaining portion of the attachment layer extending longitudinally along the strip which can be removed subsequent to the said positioning strip release portion to expose the remaining portion for subsequent attachment of the composite strip to an elongate board.

78. The composite elongate strip according to claim 77 wherein the remaining portion of the attachment layer exposed by removing said remaining strip release portion is wider than the positioning portion exposed by removing the positioning strip release portion.

79. The composite elongate strip according to claim 77 wherein the positioning strip release portion has a side edge which overlaps with and covers a side edge of the remaining strip release portion so as to define a free side edge portion.

80. The composite elongate strip according to claim 77 wherein the remaining strip release portion has an outer free edge that extends beyond the attachment layer to provide a free side edge portion for grasping during removal of the release sheet.

81. The composite elongate strip according to claim 80 wherein the outer free edge that extends beyond the attachment layer carries markings indicative of a direction of pile of the layer of fibrous floor covering material.

82. The composite elongate strip according to claim 77 wherein the positioning strip release portion is located between two remaining strip release portions each disposed along a respective edge of the strip.

83. The composite elongate strip according to claim 77 wherein the positioning strip release portion has two side edges each of which overlaps with and covers a side edge of a respective one of the remaining strip release portions so as to define free side edge portions for grasping.

84. The composite elongate strip according to claim 77 wherein each of the two remaining strip release portions has an outer free edge that extends beyond the attachment layer to provide a free side edge portion for grasping during removal.

85. The composite elongate strip according to claim 84 wherein the outer free side edge portion that extends beyond the attachment layer carries markings indicative of a direction of pile of the layer of fibrous floor covering material.
